(19) United States
(12) Patent Application Publication
(10) Pub. No.: US 2004/0052883 A1
(43) Pub. Date: Mar. 18, 2004

(54) Delayed quench apparatus

(76) Inventor: John Stanley McConnell, Salisbury, NC (US)

Correspondence Address: KoSa, 4501 Charlotte Park Drive, Charlotte, NC, 28217-1979, US

(21) Appl. No.: 10/243,007

(22) Filed: Sep. 13, 2002

(51) Int. Cl. B29C 47/88

(52) U.S. Cl. 425/72.2; 264/211.14

(57) ABSTRACT

The present invention is a quench apparatus for cooling fibers spun from a spinneret in conventional fiber making processes. The quench apparatus is positioned below a spinneret. As the molten polymers are extruded from the spinneret in the form of filaments, the quench apparatus directs cooling air onto the filaments. The present invention relates to an implement for blocking the air flow from the conventional quench apparatus by increasing or decreasing the size of the quiescent zone between the bottom of the spinneret and where the air flow first contacts the filaments. Particularly, the present invention involves a blocking implement that may be installed or removed from the quench cabinet or plenum, to increase or decrease the quiescent zone. The present invention comprises the combination of a cross-flow quench system, where the top holes of the quenching apparatus are blocked or unblocked by an implement inserted within the quenching apparatus.

### BACKGROUND OF THE INVENTION

1) Field of the Invention

The present invention relates to quench apparatus for quenching the individual filaments extruded from the spinneret. In particular, the present invention relates to an implement for blocking the airflow from a quench apparatus thereby increasing or decreasing the size (length) of the quiescent zone between the bottom of the spinneret and where the airflow first contacts the filaments. More particularly, the present invention involves a blocking implement that may be installed or removed from the quench cabinet or plenum, to increase or decrease the quiescent zone. The present invention is particularly useful when increasing the speed or throughput of the extruded material through the spinneret (increasing the output) or when switching from one type yarn to another, which requires different quench characteristics.

2) Prior Art

Fibers are broadly used in industrial applications such as automobile tires, v-belts, conveyor belts, and the like. Fibers are also used in textile applications such as sewing thread, woven and non-woven fabric, and knitted fabric. The manufactured fibers of the present invention are conventionally spun from a melt through a plurality of orifices in a spinneret.

Many physical and mechanical properties of the fibers depend on the polymer, the temperature of the polymer, the rate at which the fiber is spun and the quenching of the yarn, all of which effect the cooling rate. Thus when the yarn denier or number of filaments change, the distance between the spinneret and the onset of quenching (quiescent zone) needs to be optimized for these changes.

In a conventional system, polymer is extruded through a spinneret to form fibers and cooled at a rate in part determined by quench characteristics. U.S. Pat. No. 4,690,866 to Kumakawa et al. discloses the effects of different heating zone lengths. In Table 1, reference is made to the length (in mm) of the heating zone (quiescent zone) below the spinneret.

The key object of the present invention is to provide quench apparatus having adjustability in increasing or decreasing the quiescent zone.

### SUMMARY OF THE INVENTION

Prior to the present invention, quench systems were designed for a specific flow and a specific throughput in order to obtain a specific type of fiber or filament. The concepts of the present invention can now be applied to existing equipment thereby making it more adaptable to increases in throughput and changes in yarn denier and number of filaments.

The flow of air across the individual filaments issuing from the multiple holes in the spinneret causes the filaments to cool and solidify. As throughput of the material issuing from the spinneret increases, it is known that the quiescent zone must also increase. The present invention seeks to block the upper holes in the quench apparatus and yet maintain (or perhaps lower) the volumetric airflow through the quench apparatus and across the surface of the filaments. The cooling rate of the yarn effects the number of physical and mechanical properties of the yarn. The cooling rate is controlled by the present invention which thereby controls the physical and mechanical properties of the yarn.

The present invention relates to converting existing quench apparatus to make it more adaptable for processes, particularly those that are producing filaments at higher throughput. It is known to those skilled in the art that increasing the throughput requires that the quiescent zone must be increased so that the residence time of the filament between being extruded from the spinneret and being cooled by the quench system remains approximately the same. In this manner, the filaments produced are essentially the same as those produced at a lower throughput.

The present invention also relates to converting existing quench apparatus to make it more adaptable for processes, particularly those that desire to change the denier or polymer thereby requiring a decrease in the quiescent zone from the previously produced filaments.

Additionally, the present invention can pertain to new quench systems making them more adaptive over a larger range of throughput capacities than existed in the past.

In the broadest sense, the present invention comprises the combination of a cross-flow quench system, wherein the top holes of the quenching apparatus are blocked or unblocked. An insert is inserted or removed from the inside of the quench system and is positioned so as to block or permit more airflow through the upper portion of the quench apparatus.

### BRIEF DESCRIPTION OF THE DRAWINGS

The drawings set forth herein are merely for the purpose of illustrating and understanding the present invention and are not intended to limit the invention in any way beyond the scope of the claim set forth herein. On the other hand, the drawing may be relied on to show spatial relationships between known apparatus and the apparatus of the present invention so that those in the field of art may understand its position relative to existing and known apparatus.

FIG. 1 is a schematic side view of the prior art illustrating a quenching apparatus, a spinneret, and filaments extruded from said spinneret and surrounded by said quenching apparatus.

FIG. 2 is a schematic side view of the present invention showing a quench apparatus having inserts to block at least some of the upper holes in the quench apparatus.

### DESCRIPTION OF THE PREFERRED EMBODIMENTS

The present invention is designed to be employed with filaments spun from a spinneret. Molten polymer is heated above its melting point and is extruded through holes in the spinneret to form molten filaments which are cooled to become solid filaments as is known in the art. It is known to employ quench apparatus which cools the molten filaments thereby permitting them to solidify so that the filaments can be further processed (such as drawing them to increase their physical properties, or subjecting them to a crimping operation to introduce bulk into the filaments, or winding the filaments on bobbins or beams for shipping to a customer). Quench apparatus comes in several different forms, with the most common and preferred form being cross-flow quench. Cross-flow quench blows air across the filamentary spinneret bundle. The present invention relates only to this type of cross-flow quench system.

Suitable polymers that can be spun into filaments are polyamides, such as nylon 6, or nylon 6,6; polyester such as polyethylene terephthalate, polybutylene terephthalate, polypropylene terephthalate, polyethylene naphthalate and various copolymers; acrylic polymers such as polymethacrylate, polymethylmethacrylate; and combinations of any of the above. While this list is not meant to be exhausting, those skilled in the arts certainly realize which polymers can be melt spun. Those that can be spun according to processes and apparatus described herein are within the scope of the present invention.

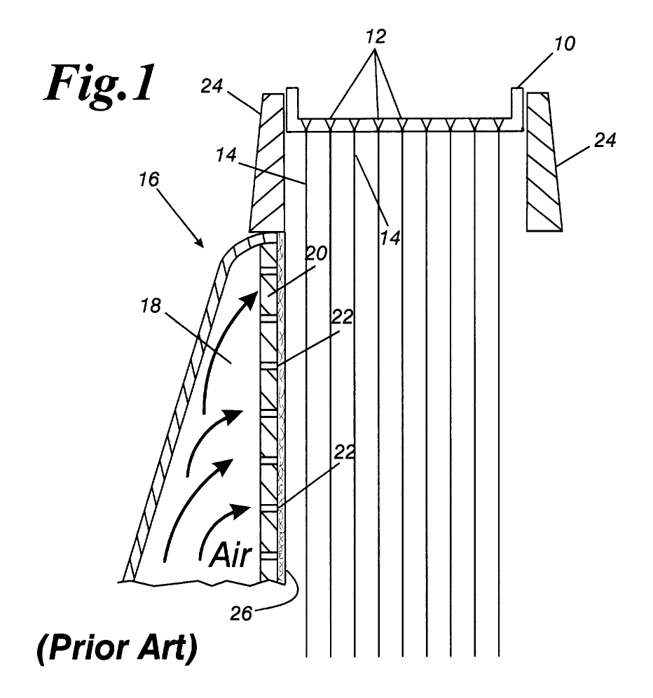

FIG. 1 illustrates one type of cross-flow quench apparatus known in the prior art. A spinneret 10 has a plurality of holes 12 through which molten polymer supplied from a source (not shown) flows to the spinneret 10 and through the holes 12 forming a plurality of molten polymer filaments 14. The number of filaments formed is a design variant among the equipment producers of spinnerets, with different number of holes and different number of rows. Typically, there may be anywhere from twenty to several thousand holes in a typical spinneret 10, depending on whether a textile filament, industrial filament, or textile staple product is being produced.

A shroud 24, of fixed length, surrounds the fiber bundle 14, to prevent any airflow from breaking the extruded molten filaments, until such time as a controlled volume of air can be directed to the filament bundle 14.

Positioned below the spinneret, attached to the shroud 24, is a quench apparatus generally indicated by reference numeral 16 which comprises an air flow quench plenum 18, generally positioned on the back side of the extrusion apparatus. The quench plenum 18 is hollow on the inside, such that air flows from a source (not shown) to the plenum 18, and out the plenum faceplate 20 which contain a plurality of perforations/holes 22. The faceplate 20 is parallel with the extruded filaments 14, on their path of travel. The air exiting the holes 22 flows to and through an airflow rectifier 26, which gives a uniform velocity distribution across the path of the filaments extruded from the spinneret, generally 90 degrees from the path of the filaments. Airflow rectifiers are commonly made from perforated mesh (metal or high temperature plastic), or an air permeable foam material. Thus FIG. 1 is a side view of the spinneret bundle filaments 14, cooled from the rear by air in plenum 18 exiting through perforations/holes 22 and airflow rectifier 26, and flowing across the filaments. Additionally, the front side of FIG. 1 (the side opposite plenum 18) is left open so that the filaments can be seen and monitored for proper production, shut down, and startup.

The components can be made of any material able to withstand the temperatures typically encountered in extruding polymers. Various polymers have various melt-point temperatures, but generally materials that can withstand 200 degrees Celsius would be suitable for quench apparatus.

In prior art processes changes in the quiescent zone length can only be accomplished by the lengthy process of lowering the quench assembly and replacing the shroud 24 with one of a different length.

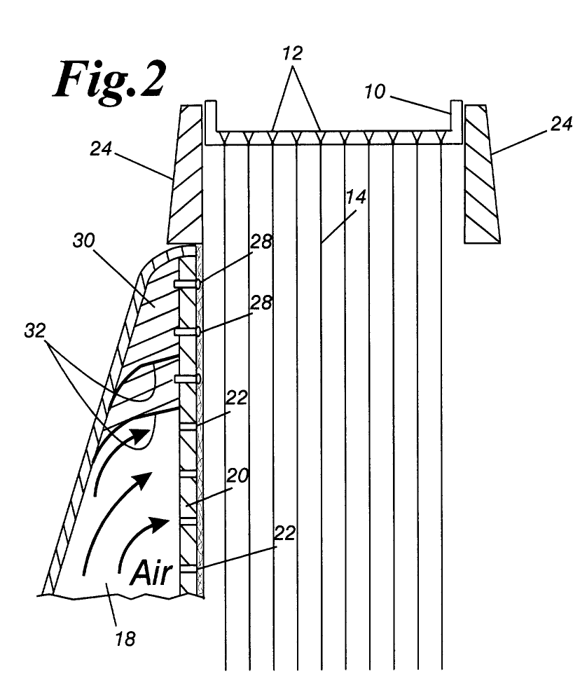

In FIG. 2, one or more curvilinear inserts 30 is positioned within the air plenum 18 and secured to the quench faceplate 20 by means of fasteners 28. The advantage of the inserts 30 is that they are tapered in the same manner as the plenum chambers 18 such that the flow of air is uniform across the filaments 14 issuing from the quench faceplate 20. It is known that more air would exit the holes near the end of the plenum as opposed to holes near the beginning of the plenum for a plenum having constant diameter and uniform holes. Thus, plenums such as 18 are tapered so that the pressure near the end of each plenum is more or less the same as that of the pressure near the beginning of the plenum. To maintain this concept, the inserts 30 have a curvilinear surface 32 that directs the air uniformly and with as little turbulence as possible.

The inserts 30 are designed for a specific height and should one wish to increase the quiescent zone three inches in length, then either one three inch insert is employed, or three one inch inserts may be employed. Thus the inserts can be any height desired. It is therefore possible to insert or remove one or more blocking implements in the quench apparatus to respectively increase or decrease the quiescent zone. As process conditions involving the length of the quiescent zone need to be changed, this invention allows a rapid means to achieve these means

Thus it is apparent that there has been provided, in accordance with the invention, apparatus that fully satisfies the objects, aims, and advantages set forth above. While the invention has been described in conjunction with specific embodiments thereof, it is evident that many alternatives, modifications, and variations will be apparent to those skilled in the art in light of the foregoing description. Accordingly it is intended to embrace all such alternatives, modifications, and variations as fall within the spirit and broad scope of the claims.

What is claimed is:

1) The combination of a cross-flow quench apparatus and a blocking implement in said quench apparatus, comprising:
a) a cross-flow quench apparatus designed to be positioned below a spinneret for extruding molten polymers into filaments, said quench apparatus for directing cooling air onto said filaments, and
b) a blocking implement secured to said quench apparatus for blocking a portion of said cooling air onto said filaments.

2) The combination of claim 1, wherein said quench apparatus has a hollow inner contour and said blocking implement fits said inner contour.

3) The combination of claim 2, wherein said quench apparatus has a source of cooling air and a perforated faceplate, whereby said cooling air flows through said inner contour, and through said faceplate.

4) The combination of claim 3, wherein said blocking implement is an insert designed to snuggly fit within said quench apparatus, adjacent said upper most perforated faceplate.

5) The combination of claim 3, wherein said quench apparatus has an airflow rectifier affixed to said perforated faceplate.

6) The combination of claim 5, wherein said airflow rectifier is a perforated mesh.

7) The combination of claim 5, wherein said airflow rectifier is an air permeable foam material.

8) The combination of claim 1, wherein said blocking implement has a curvilinear surface for uniformly directing airflow.

9) The combination of a spinneret and a quench apparatus for spinning and cooling filaments, comprising: a cross-flow quench apparatus designed to be positioned below a spinneret for extruding molten polymers into filaments, said quench apparatus for directing cooling air onto said filaments, and a spinneret, wherein said quench apparatus includes a blocking implement secured to said quench apparatus for blocking a portion of said cooling air onto said filaments.

10) The combination of claim 9, wherein said blocking implement has a curvilinear surface for uniformly directing airflow.

11) The combination of claim 9, wherein said spinneret includes a shroud positioned around and between said spinneret and said quench apparatus thereby creating a quiescent zone.

12) The combination of claim 11, wherein said quench apparatus is secured to said shroud.

13) The combination of claim 9, wherein said quench apparatus has a source of cooling air and a perforated faceplate, whereby said cooling air flows through said faceplate.

14) The combination of claim 13, wherein said blocking implement is an insert designed to snuggly fit within said quench apparatus, adjacent said upper most perforated faceplate.

15) The combination of claim 13, wherein said quench apparatus has an airflow rectifier affixed to said perforated faceplate.

16) The combination of claim 15, wherein said airflow rectifier is a perforated mesh.

17) The combination of claim 15, wherein said airflow rectifier is an air permeable foam material.

18) The process of extruding molten polymer through a spinneret having a quiescent zone and a quench apparatus, comprising: changing the size of the quiescent zone by inserting or removing a blocking implement in said quench apparatus; extruding molten polymer through said spinneret to produce filaments, and directing cooling air from said quench apparatus onto said filaments.

19) The process of claim 18, wherein said quench apparatus has a hollow inner contour and said blocking implement fits said inner contour for blocking a portion of said cooling air.

20) The process of claim 18, wherein said blocking implement is an insert designed to snuggly fit within said quench apparatus.
